(19) United States
(12) Patent Application Publication
(10) Pub. No.: US 2002/0059186 A1
(43) Pub. Date: May 16, 2002

(54) Method and apparatus for automatically selecting plants and for automatically arranging planting groups

(76) Inventors: Angelika Weber, Muenchen (DE); Karin Greiner, Dachau (DE)

Correspondence Address: Heribert Muensterer, 12290 Wake Forest Road, Clarksville, MD, 21029, US

(21) Appl. No.: 09/978,284

(22) Filed: Oct. 17, 2001

(30) Foreign Application Priority Data
Oct. 23, 2000 (DE) 100 52 454.0

(51) Int. Cl. G06F 7/00

(52) U.S. Cl. 707/1

(57) ABSTRACT

The present invention relates to a method and an apparatus for automatically selecting plants according to various criteria and/or for automatically working out a plant selection for planting groups. It is here intended that basic questions including questions on location and properties are submitted from a memory in a first step. On the basis of the answers to said selection questions, a planting proposal is worked out by means of a computing unit. Location criteria and plant features are taken into account, as well as availability criteria and accessory data. The planting proposal is automatically output with the help of output means, the result including purchase lists, order lists and/or plant information (FIG. 1).

### CROSS-REFERENCE TO RELATED APPLICATIONS

The present application claims priority under 35 U.S.C. § 119 of German Patent Application No. 100 52 454.0, filed on Oct. 23, 2000.

### BACKGROUND OF THE INVENTION

1. Field of the Invention

The present invention relates to an apparatus and to a method for automatically selecting plants or for working out planting proposals.

2. Discussion of Background Information

The prior art already discloses a very great variety of publications regarding plant selection, garden design, arrangement of plants, etc. These constitute, on the one hand, literature dealing with esthetic aspects and design work and the arrangement of gardens, garden beds, houseplant configurations, or the like. Another large field of publications describes plants with respect to their characteristics, such as floral structure, flower color, height of growth, or the like, such descriptions being most of the time present in the form of so-called plant portraits.

When preparing a planting measure, a layman is thus faced with the problem that he must take into account a host of individual factors and publications to find his desired plants. As soon as he got some idea as to how his planting project should look like, the difficulty arises that the plants must be checked as to whether it makes sense to combine them under botanical and horticultural aspects and whether they can be arranged in an attractive way. Even if the user has managed this step with more or less success, the question arises for him where the plants desired by him are available and which further aspects he must consider in his planting project. When the user is visiting a horticultural enterprise, such as a garden center, a nursery, a DIY superstore with a horticultural department, or the like, he is most of the time left alone with his problems at those places as well, or he must ask for information in a troublesome way.

Even with a careful preparation, the result is mostly by chance and not optimum in most cases.

U.S. Pat. No. 5,440,479 describes an automatic sales terminal for cut flowers. Prearranged standard floral bouquets are here offered to the buyer. If the buyer does not accept the same, he himself can combine bunches of cut flowers among the flowers offered. Furthermore, the sales terminal offers holders, such as vases. The submission of questions to the user is not intended, nor the assignment of answers to specific storage contents.

A database system for advising customers in a fully automated way is already known from DE 197 05 616 A1. This system, however, does not offer any possibilities of selecting plants.

### SUMMARY OF THE INVENTION

It is the object of the present invention to provide a method and an apparatus for automatically selecting plants, which, while being easily usable, yield an optimum result as to the plants to be selected and the necessary information all the time, i.e. for the inexperienced user.

According to the invention this object is achieved by the features of the independent claims; the corresponding subclaims show further advantageous developments of the invention.

As for the apparatus for automatically selecting plants, it is intended that said apparatus comprises at least one input station, at least one memory, at least one computing unit, and at least one output means, the memory comprising a plurality of areas, namely at least one first area in which selection questions are stored for the user, at least one second area in which location criteria of plants are stored, and at least one third area in which plant features of a multitude of plants are stored. The computing unit is here designed for the automatic submission of selection questions from the first area of the memory into the input station and for the automatic linkage of the answers to the selection questions with at least the second and third area of the memory and for the automatic output of plant proposals and/or plant information by the output means.

As for the method for automatically selecting plants, the following work steps are intended: automatically providing standardized selection questions at an input station, automatically assigning answer data of the input station to location criteria and/or plant features in a memory area, and automatically selecting plants in accordance with the location criteria and/or plant features, and displaying the results in output means.

Both the method according to the invention and the apparatus according to the invention are characterized by a number of considerable advantages.

With the invention it is possible for the first time to solve such a complex problem in a fully automatic way, i.e. to make an optimum selection among the available plants for a planned planting measure. For instance, it is possible to select the plants on the basis of the planting measures and locations planned by the user. For instance, the planting operation may regard a balcony box, a garden bed, a greenhouse, a roof garden, a rock garden, a window sill, an indoor room, or the like. Within the scope of the location criteria or location data, a first pre-selection is made by means of the computing unit among the plant data stored in the memory. Subsequently, a further selection is made in a fully automatic way among the plants suited for the location in question. The light conditions are e.g. included in this selection. It can also be taken into account whether the location is sunny or shadowy or an artificial-light location, etc. Furthermore, information on the soil condition and quality is taken into account. The plants are selected automatically as to whether their soil is heavy, sandy, barren, deep, acidic or basic or whether another substrate, e.g. artificial soil, is concerned. Further location factors are also taken into account, e.g. wind conditions, water conditions, temperature, mechanical load on the plants by man, animal, or other effects, exhaust-gas effects, care intensity or sight screen factors.

According to the invention it is possible to take into account the users wishes as to the properties of the plant or the planting group, e.g. height of growth, form of growth, floral structure, flower color, flowering period, as well as special characteristics of the plants. The latter include, for instance, sight screen, necessary care intensity, water consumption, nutrient consumption, scent or whether the plants are to be useful plants or ornamental plants. The desired style can also be taken into account. However, it can also be queried whether the plants desired by the user are to be tolerated by children and/or animals, whether they are suited with respect to their toxic or their allergic effect, whether they can be prickly or thorny, whether they must meet Feng Shui or esoteric requirements, and/or whether there are limitations with respect to the purchasing costs and the life span of the plants. It is also possible to make a selection whether the plants are to grow in earth or in a container, in soil substrate, hydroculture, or the like.

According to the invention the user is thus faced with a multitude of such selection questions in an automatic sequence, and these questions must successively be studied and answered by the user. The selection of the selection questions and their order or sequence is here fully automatic, the computing unit automatically linking the submission of the respectively subsequent selection questions with the answer to the preceding questions, so that unnecessary or absurd questions are automatically suppressed.

After the automatic submission of the selection questions and the assignment of the corresponding answers, a plant proposal or a planting suggestion is automatically worked out by means of the computing unit. The computing unit checks the plant data stored in the memory, first of all with respect to the location questions and the questions regarding the desired properties. The location criteria as well as the plant features of the stored plants are here compared one after the other, so that the result is present as a selection or list of plants which are optimally suited for the predetermined intended use.

This result is output to the user by means of the output means. The output means will be described in detail further below.

In a preferred development of both the apparatus and the method, availability criteria and availability data of the plants are additionally checked in the selection of the plants. To this end the apparatus comprises a further memory area. This memory area may e.g. contain the inventory lists or stock of a horticultural enterprise. It is thereby avoided that plants are suggested to the user that are not at all available or not deliverable at the moment. Furthermore, it is here e.g. also checked whether the season or planting time is the right one to prevent the user from buying or planting plants that cannot be used at the intended time.

In a particularly advantageous development of the method according to the invention, it is further intended that schematized locations are formed in the automatic assignment of the answer data to the location criteria of the plants. The computing time can thereby be shortened quite considerably because standardized and already prepared suggestions can be resorted to for specific locations and intended uses. For instance, standardized proposals can be submitted for the planting of balcony boxes or flower tubs in spring or early summer.

In a further advantageous development of the method, it is intended that compatibility data of the plants are taken into account in the automatic selection of the plants. Preferably, flower color, height of growth, flowering period, floral structures, leaf size, form of growth, water consumption and/or nutrient consumption are here taken into account. This avoids a situation where the plants are arranged in a mutual configuration such that they would e.g. overgrow one another, where some plants would need much more water or nutrients, or the plants would be no match with respect to flower color or floral structure. On the other hand, it can be shown how the plants have a mutual positive effect on one another. Hence, it is automatically achieved that the selected plant arrangement in its entirety harmonizes under botanical, horticultural and esthetic aspects.

In an advantageous development of the invention, it is also intended that with the display of the results the user has the possibility of making an individualized corrective entry and/or of rejecting the plant suggestion. According to the invention the automatic process will then run through the preceding step of the selection questions once again. The user can here specify and/or correct the answers given by him if he has not accepted the result of the planting proposal.

It is particularly advantageous when the display of the results within the scope of the planting proposal includes pictures of the plants (on photos or drawings) or at least one picture of the whole planting proposal (plant arrangement) and/or further details, such as planting instructions, plant protection instructions, care instructions and/or plant portraits. Thus, all of the aspects of interest to the user can be considered in a fully automatic way and transmitted with respect to the information. Such a visualization gives the user a detailed idea of his planting project.

It is of particular advantage when the user obtains an order and/or purchase list as a result of the automatically running selection process.

To be able to pose the location questions in a precise and automatic way and to be able to select the corresponding location data of the plants, it is advantageous according to the invention when, as far as the location data are concerned, the method considers data on the planting place, the light conditions, the soil condition and/or further location factors.

Since plantings or plant arrangements must also satisfy practical and esthetic requirements, it is particularly advantageous when the apparatus includes a further memory area in which accessory data are stored and when in the selection of the plants the automatic method assigns such accessory data to the plants. Accessory data may e.g. be the right and optically and esthetically preferred selection of plant containers. Containers may be chosen which avoid water-logging, which are sufficiently large, optically attractive, suited for the respective weather conditions (frost proofness, UV resistance, etc.). Furthermore, climbing aids or plant supports that are needed with respect to the accessory data can be selected. Automatic watering or sprinkling systems, also stepping stones, bed borders, lighting fixtures, or also covers for stairs, paths or terraces can be offered. This applies equally to automatic or manual fertilization. Preventive measures for pest prevention or for the actual pest control are also possible, e.g. traps for insects, or the like. The accessory data may also comprise data regarding the planting operation proper, e.g. the introduction of substrate or soil additives, the right selection of suitable soil, etc. Furthermore, the accessory data may include decoration, or the like, which can be added in a particular way to the selected plant arrangement, e.g. glass balls, figures, ornamental stones, or the like.

The accessory data are preferably output together with the results with the help of the output means.

The input station is preferably in the form of a user terminal. It is equally advantageous when the input station is conceived as an internet terminal so that the user can request the automatic plant selection via the internet

The results are preferably displayed on a screen and are output in an advantageous manner by means of a printer in paper form. However, it is also possible to provide the user with storage media, e.g. a disk or a CD on which the result of the selection process, including the representation of the individual plants, the representation of the planting arrangement as well as additional information, is stored.

As shown by these explanations, the invention saves a considerable amount of time and money for the user and e.g. also for a horticultural enterprise because a qualified employee need no longer be questioned or hired. In addition, a time-consuming and troublesome search in a host of publications is not necessary.

### BRIEF DESCRIPTION OF THE DRAWINGS

The present invention will now be described with reference to an embodiment taken in conjunction with the drawing, in which:

FIG. 1 is a simplified schematic illustration of the hardware of the apparatus according to the invention; and

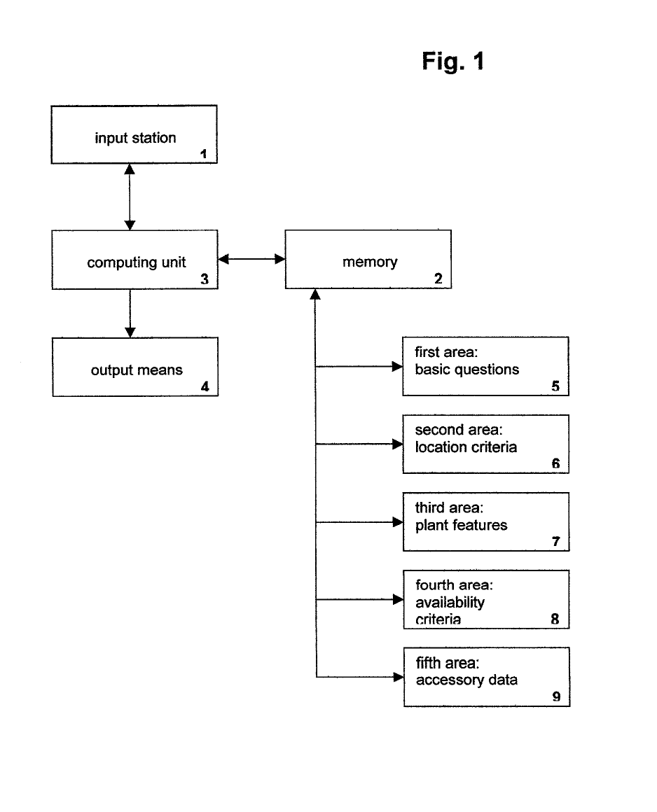

FIG. 2 is a simplified illustration showing the sequence of the method according to the invention.

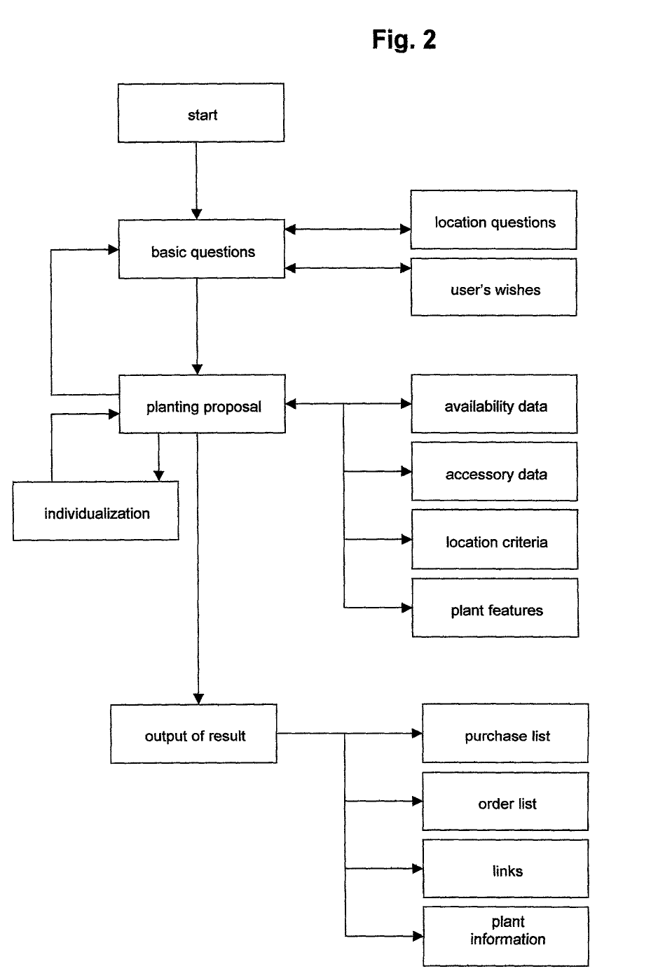

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

FIG. (1) schematically shows the hardware of the apparatus according to the invention. First of all, this apparatus comprises an input station (1). The input station preferably comprises a screen and an input means (keyboard or mouse). However, the input station may also comprise a touch screen or an internet terminal.

Furthermore, the apparatus comprises a computing unit (3) which has assigned thereto a memory (2). The computing unit (3) with the memory (2) may directly be assigned to the input station or connected thereto via a data line.

Memory (2) preferably comprises a plurality of memory areas, namely a first memory area (5) for storing basic questions, a second memory area (6) for storing location criteria, a third memory area (7) for storing plant features, a fourth memory area (8) for storing availability criteria, and a fifth memory area (9) for accessory data.

The computing unit is connected to output means (4) designed in the form of a screen, a printer or in the form of a data line for connection to the personal computer of a user via internet, or the like.

FIG. (2) shows the simplified sequence of the method according to the invention.

After the automatic selection process has been started, the computing unit (3) first submits a sequence of basic questions automatically to the user. These basic questions are selected by the computing unit one after the other according to logic and useful criteria. Depending on the respective answer from the user, the computing unit looks for the next suitable question, automatically posing the same to the user at the input station.

In the embodiment, the first basic questions primarily regard the desired location of the planting measure. Hence, in one of the first questions one wants to know whether outdoor planting is intended or whether planting is to be carried out under glass, e.g. in a greenhouse, whether houseplants are to be selected, for instance for a window, a winter garden or an indoor room. The user can indicate whether he wishes to plant a garden bed or a balcony box, a flower tub, or an individual upright container. He can indicate whether an ornamental garden, a vegetable garden, a roof garden, a pond planting, a rock garden, a greenhouse, a grave, or the like, is concerned. It goes without saying that the above list is not complete.

Following the classification of these general basic requirements, the user is automatically asked questions regarding the illumination or lighting of the intended location. For instance, it may be asked whether the location is sunny or shadowy or whether it is a location in half shadow or artificial light. Furthermore, it can be clarified whether already existing further plantings or plants exist in direct vicinity, e.g. tall trees.

A further group of the location questions to be presented automatically regards the soil or soil condition. A distinction must be made whether the soil is heavy, sandy, barren, deep, acidic or basic or whether a planting operation is to be carried out in a planting pot or in hydroculture or in a substrate.

Furthermore, the location questions to be presented automatically include other factors, such as wind, rain, temperature, mechanical load by man or animal or exhaust gases. Questions regarding the desired sight screen or care intensity (permanent care, accumulation of leaves in autumn, etc.) are also posed.

It goes without saying that the above-mentioned location questions are not complete. The location questions are assigned automatically, so that absurd or unnecessary questions are not posed to the user. Furthermore, the location questions are chosen in dependence upon the plants listed in the memory. If the existing plant offer or the memory stock rules out certain locations right from the start, such questions will be suppressed automatically.

After clarification of the location questions, the user is automatically faced with selection questions which regard the characteristics desired for the plants to be selected. For instance, questions are asked with respect to the care intensity, the watering and fertilizing habits of the user (water consumption, nutrient consumption). It is clarified whether the plants are to be tolerated by children or animals, whether they must meet toxic or allergic criteria. It is also asked whether the user wishes to use the plant as a sight screen. The question whether the plant can be thorny or prickly is also checked. Furthermore, it is asked whether the plant is to be grown in soil or hydroculture or in another way. Questions regarding costs and the desired life period may also be asked. In addition, questions of an ideological or other kind are possible, e.g. questions regarding the style or whether the plant is to be selected taking into account Feng Shui aspects or esoteric aspects, or the like. The question whether the plant is to be an aromatic plant and/or a medicinal plant is here also posed. Since the answers to the selection questions are provided automatically, a comparison is now made according to the invention with the second and/or third area (6), (7) of the memory (2). Location criteria and plant features are stored in these areas. On the basis of the predetermined criteria the computing unit determines the suitable plant or plants and stores their data or memory address in an intermediate memory. In the illustrated embodiment, a check is additionally made with the availability criteria stored in a fourth memory area (8). These criteria regard e.g. both the planting time and the stock or inventory list of the horticultural enterprise to be chosen.

Plants which are excluded with respect to the planting time, season and/or stock are automatically suppressed in the working out of the plant proposal.

Furthermore, the computing unit takes into account the data of a fifth memory area (9) which lists accessory data. The accessory data comprise, for instance, the selection of suitable containers under botanic and esthetic aspects. For instance, it is suggested to the user to select a balcony box with a watering system, to use a terracotta container, or to consider a corresponding outer pot. Constructional accessories, such as stepping stones, bed borders, lighting fixtures, or covers for stairs, paths or terraces can also be included. In addition, necessary watering systems may be offered to the user; these take e.g. into account the care intensity chosen by the user. Measures required for the plant can also be indicated, e.g. climbing aids and plant supports. The user may also be advised to take pest controlling or preventing measures as prophylactic measures, e.g. by providing insect traps, or the like. Decoration, such as glass balls, animal figures, fanciful figures, or the like, can also be assigned to the plant proposal.

Following the automatic selection and assignment of the corresponding data, a planting suggestion is submitted to the user. This suggestion is preferably made on a screen, but it is also possible to directly print the planting proposal. The user is here provided not only with the corresponding data, but a photo or picture is also shown to him for each plant. In addition, the user automatically obtains an overall arrangement of the plants, so that he can look at the entire configuration.

The user has then the option to accept the planting proposal, so that the result can be output. However, he has also the option to reject the planting proposal on the whole, so that the process will return to the basic questions. Such a sequence makes e.g. sense when the user rejects one or several of the suggested plants and when the planting proposal is therefore not acceptable to him.

Alternatively, the user can also make an individualization by deleting e.g. individual plants or by substituting the same by other plants, with a new planting proposal being then made to him.

FIG. (2) shows various options in the output of the result. On the one hand, the user receives a purchase list on which the individual plants and accessories are listed in detail. When the method of the invention is employed in a horticultural enterprise, it may be specified at the bottom where he can obtain the individual plants at said place. It is also possible to inform him which one of several horticultural enterprises is best suited for him. In addition, the purchase list comprises a detailed list of the costs from which the user can gather the total costs.

Alternatively, an order list which contains data similar to those of the purchase list can also be offered to the user. The order list may e.g. be sent via internet or fax or in another way to a garden center which delivers the desired products to the user. An electronic buying operation is here possible which e.g. may be directly settled via credit cards.

The output of the result has also the function to provide the user with further literature or information or to give him information on horticultural centers, book presentations, TV broadcasts, or the like.

Furthermore, the output of the result includes plant information which is printed out in a corresponding form and/or is present on an electronic storage medium. For instance, the user can receive planting instructions which specify in detail how the user is to use the plants purchased. The user is provided with care/cultivation instructions which tell him when he has to take which kind of care measure. The user can obtain detailed lists regarding the protection of the plants to react e.g. to pest infestation, adverse weather conditions, frost, or the like, by taking suitable measures. The plant information includes detailed portraits of the plants and arrangements of the purposeful or useful further accessories.

In an alternative development of the method, it is also possible to define in the case of the basic questions whether the user has already chosen in a quite selective way one or several plants he wishes to plant. It is then possible to choose the suitable location questions or questions regarding desired characteristics or to suppress such questions altogether. If the user predetermines e.g. a specific plant, it can be checked whether this plant makes sense for the location desired by the user or whether he is aware of the characteristics of the plant. The plant can be entered with its botanical name and also e.g. under its trivial name. In the automatic computing of the planting suggestion, the availability criteria and data will then be checked specifically.

It follows from the above explanation that the invention is concerned with a fully automatic method in which the computing unit assigns plants, plant information and other information to the input data from the various areas of a memory in order to work out a plant proposal. The input data are here automatically requested in a logic sequence by posing suitable selection questions to the user. Thus the whole process of the method takes place without any human interaction and without resorting to human mental activities. Hence, a purely automatic technical method is here concerned.

The method according to the invention can in particular be employed in all further sequential steps to be carried out automatically, in particular via internet and e-commerce. It is here also possible to request additional user data including age and sex of the user and his dwelling conditions and leisure habits. It can here be taken into account whether the user has a garden of his own, how big this garden is, which planting measures have already been taken or whether the user has an apartment, a terrace, a roof garden or a balcony. These data can also be taken into account in the selection of the plant proposals.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. Automatic plant selecting apparatus comprising at least one input station (1), at least one memory (2), a computing unit (3) and output means (4), characterized in that said memory (2) comprises a first area (5) in which basic questions are stored, as well as a second area (6) in which location criteria of plants are stored, and a third area (7) in which plant features of a multitude of plants are stored, said computing unit (3) being designed for automatically submitting basic questions from the first area (5) of said memory (2) to said input station (1) and for automatically linking the answers to said basic questions with at least the second and third area (6), (7) of said memory (2) and for automatically outputting plant suggestions and/or plant information by said output means (4).

2. The apparatus according to claim 1, characterized in that said memory (2) comprises a fourth area (8) in which availability criteria of plants are stored.

3. The apparatus according to claim 1, characterized in that said memory (2) comprises a fifth area (9) in which accessory data are stored.

4. The apparatus according to claim 1, characterized in that said input station (1) is designed in the form of a customer terminal.

5. The apparatus according to claim 1, characterized in that said input station (1) is designed as an internet terminal.

6. The apparatus according to claim 1, characterized in that the results are displayed on a screen.

7. The apparatus according to claim 1, characterized in that said results are printable by means of a printer.

8. A method for automatically selecting plants, comprising the following steps:
automatically providing standardized selection questions at an input station (1),
automatically assigning answer data of said input station (1) to location criteria and/or plant features in a memory area (6), (7),
automatically selecting plants according to said location criteria and/or plant features, and displaying the results in output means (4).

9. The method according to claim 8, characterized in that in the selection of the plants a comparison is made with availability data of the plants to be selected.

10. The method according to claim 8, characterized in that schematized locations are formed in the automatic assignment of the answer data to said location criteria of the plants.

11. The method according to claim 8, characterized in that compatibility data of the plants are taken into account in the automatic selection of the plants.

12. The method according to claim 8, characterized in that said compatibility data include flower color, height of growth, flowering period, floral structure, growth, style, water consumption and/or nutrient consumption.

13. The method according to claim 8, characterized in that after display of the results individualized corrective entries are made at said input station (1) for the repeated automatic run of the process steps.

14. The method according to claim 8, characterized in that the display of the results includes pictures of the plants, at least a picture of the whole planting proposal, planting instructions, care instructions, plant protection instructions and/or plant portraits.

15. The method according to claim 8, characterized in that the display of the results includes an order and/or purchase list.

16. The method according to claim 8, characterized in that said location data comprise data on planting place, light conditions, further location factors and/or soil condition.

17. The method according to claim 8, characterized in that accessory data are assigned in the selection of the plants.

18. The method according to claim 17, characterized in that said accessory data include data on plant containers, climbing aids, watering systems, fertilization, pest prevention, planting medium and/or decorative articles.

19. The method according to claim 17, characterized in that said accessory data are output with the results with the help of said output means (4).
